(19) United States
(12) Patent Application Publication
(10) Pub. No.: US 2008/0178099 A1
(43) Pub. Date: Jul. 24, 2008

(54) Method of using block diagram to combine logic expressions

(76) Inventor: Tao Feng, Burnaby (CA)

Correspondence Address: TAO FENG, 901-6175 NELSON AVENUE, BURNABY, BC, V5H-4E7, omitted

(21) Appl. No.: 11/624,217

(22) Filed: Jan. 18, 2007

(51) Int. Cl. G06F 3/048

(52) U.S. Cl. 715/764

(57) ABSTRACT

A complicated logic expression uses 4 operators “and”, “or”, “not” and “( )” to combine simpler logic expressions. A method is provided to use lines and blocks to represent these operators and separate the logic expressions.

### BACKGROUND OF THE INVENTION

1. Field of the Invention

The present invention is method of using block diagram to combine simpler logic expressions to compose a more complicated logic expression in a graphic user interface.

2. Description of Related Art

The result of a combination of logic expressions is a more complicated logic expression. A complicated logic expression in text format composed with “and”, “or”, “not” and “( )” is hard to build for people who do not have technical background. Many applications do provide graphical logic expression builder but the way they handle combinations of logic expressions is using text. A graphic way to combine logic expressions is very helpful to users. FIG. 1 is a block diagram of combination of logic expressions.

### SUMMARY OF INVENTION

A block diagram for combination of logic expressions uses horizontal line to represent “and”, vertical line to represent “or”, rectangle to represent “not”. Logic expressions are in the cells formed by lines and rectangles. Each line visually separates items at the two sides but always leaves visible space to other lines. No line connects to or goes across other lines or rectangles (See FIG. 2 wrong lines).

### BRIEF DESCRIPTION OF THE DRAWINGS

FIG. 1 Block diagram of combination of logic expression

FIG. 2 wrong lines

FIG. 3 logic blocks

FIG. 4 wrong logic blocks

FIG. 5 Add a logic expression

### DETAILED DESCRIPTION OF THE INVENTION

1 Block diagram represents combination of logic expressions includes all or some of the following types of items

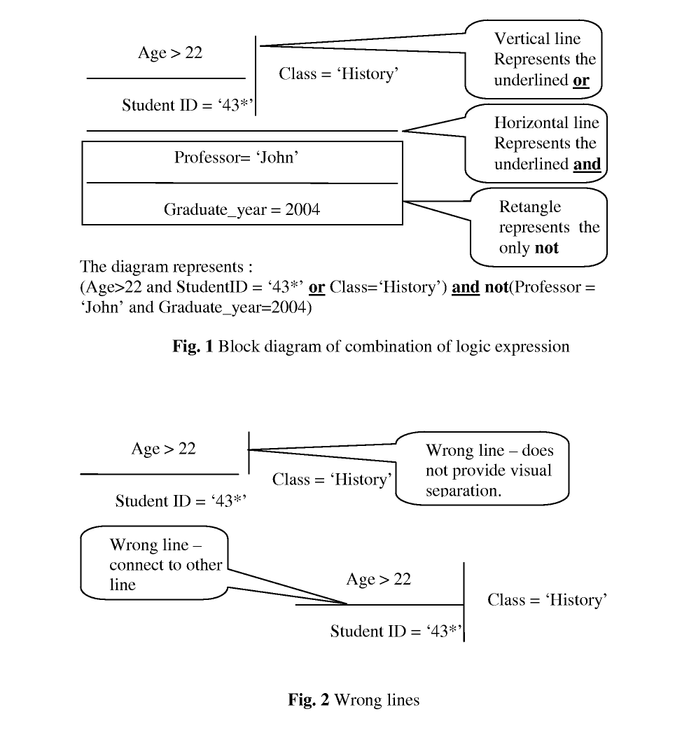

Vertical line, each line means a “or” operator applies on the result of the largest logic blocks at left and right side next to it (See FIG. 1 Block diagram of combination of logic expression);

Horizontal line, each line means an “and” operator applies on the result of the largest logic blocks at upper and down side next to it (See FIG. 1 Block diagram of combination of logic expression);

Rectangle, each rectangle means a “not” operator applies on the result of the largest logic block inside it (See FIG. 1 Block diagram of combination of logic expression);

Logic expression, each logic expression is separated by “or” vertical lines and “and” horizontal lines;

and having the following features

Each line provides visual separation to the items at both sides.

Each cell formed by “and” horizontal line and “or” vertical lines has only one logic expression.

No line connects to or goes across any other lines or rectangles.

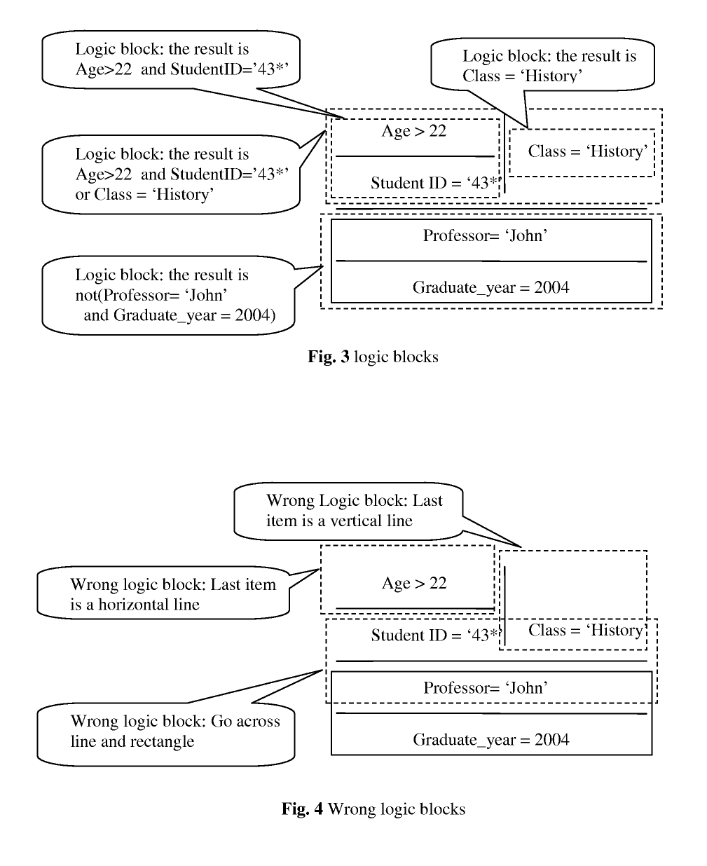

Definition of Logic block: Draw a rectangle surrounding one or more logic expressions, “or” vertical lines, “and” horizontal lines and “not” rectangles. If the rectangle satisfies the following conditions, items inside the rectangle forms a logic block (See FIG. 3 logic blocks).

None of the four lines of the rectangle go cross any horizontal “and” lines, vertical “or” lines and “not” rectangles (See FIG. 4 wrong logic blocks).

The last item inside the rectangle next to a vertical line of the rectangle is not a “or” vertical line (See FIG. 4 wrong logic blocks).

The last item inside the rectangle next to a horizontal line of the rectangle is not a “and” horizontal line (See FIG. 4 wrong logic blocks).

Result of a logic block: If only one logic expression in the logic block, the result of the logic block is the logic expression. Otherwise, the result of the logic block is a logic expression developed by a logic operator represented by a vertical line or horizontal line that divides the block into two parts or a rectangle surrounding all logic expressions in the block.

The result of the largest logic block of the diagram is the logic expression the diagram represents.

2 Steps to use block diagram combine logic expressions

(a) Add first logic expression in the block diagram.

Before this step, there is nothing in the diagram. Logically, it is valid to put the first logic expression anywhere in the diagram.

(b) Identify a logic block and apply a “not” operator on it if applicable. Applying “not” operator by add a rectangle to the logic block. The “not” rectangle should only surrounding items in the chosen logic block.
(c) Identify a logic block and add a logic expression that has “or” or “and” relationship with the logic block.

If a “or” operator applies on the result of the logic block and the new adding logic expression. Put a vertical line beside the logic block and put the new adding logic expression on another side of the line. The vertical line must provide visual separation to the logic block and the new added logic expression and must not connect to or go across any other lines and rectangles. There should not be any item between the logic block and the vertical line and between the vertical line and the new added logic expression.

If a “and” operator applies on the result of the logic block and the new adding logic expression. Put a horizontal line beside the logic block and put the new adding logic expression on another side of the line. The horizontal line must provide visual separation to the logic block and the new added logic expression and must not connect to or go across any other lines and rectangles. There should not be any item between the logic block and the horizontal line and between the vertical line and the new added logic expression.

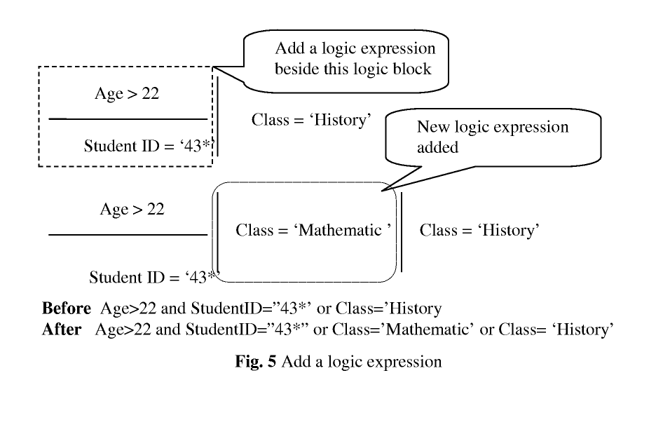

If there is not enough room for the new items, existing items may need to move to create room (See FIG. 5 Add a logic expression).

(d) Exchange locations of two logic blocks if necessary

Location is very important when forming a desired logic block. The basic principle of exchange locations of two logic blocks is that the result of the smallest logic block contains both of them won't be affected. For instance, “expression1 and expression2 and expression3” is same with “expression3 and expression2 and expression 1”.

What is claimed is:

1. A method of using block diagram to combine logic expressions, the method comprising the steps of:
(a) Add first logic expression in the block diagram
(b) Identify a logic block and apply a “not” operator on it if applicable
(c) Identify a logic block and add a logic expression that has “or” or “and” relationship with the logic block
(d) Exchange locations of two logic blocks if necessary
(e) Repeat (b) to (d) until all logic expressions are added.
